(19) United States
(12) Patent Application Publication
(10) Pub. No.: US 2009/0278493 A1
(43) Pub. Date: Nov. 12, 2009

(54) Intra-package battery charging apparatus and process for distributed products

(76) Inventor: Ray M. Alden, Raleigh, NC (US)

Correspondence Address: Ray M. Alden, 808 Lake Brandon Trail, Raleigh, NC, 27610, US

(21) Appl. No.: 12/151,788

(22) Filed: May 10, 2008

(51) Int. Cl. H02J 7/00

(52) U.S. Cl. 320/108

(57) ABSTRACT

The invention described herein represents a significant improvement in retail product differentiation. A retail battery charging method and apparatus comprises a battery charger element that is powered by electricity from a retailer's infrastructure and a battery element that is contained within a product's packing and whereby the battery is charged by the retailer while it is being display upon retail shelving such that when purchased by a consumer, the battery is fully charged for immediate use.

### BACKGROUND

1. Field of Invention

This invention relates to charging of batteries and to wireless power adaptors. In some embodiments batteries are charged while they are contained in product packaging displayed for sale in a retail store or otherwise during their distribution. When a consumer purchases the product such batteries contained within their product packaging are fully charged and ready to be utilized immediately.

2. Description of Prior Invention

Many product packaging techniques are known in the prior art. Electronic products are often packaged with rechargeable batteries that must be charged for between 1 hour to 24 hours before they can be utilized. Many battery charger systems are known in the prior art including hardwired chargers that plug into AC outlets and into batteries. Also known in the prior art are wireless charger components that utilize modulated wireless energy to induce a current to be stored in a battery such systems utilize electromagnetic energy such as RF, magnetic fields, or electric fields to induce a current to be stored in a battery. The present invention incorporates elements from packaging, batteries, chargers, and product distribution infrastructure to create a new value to consumers. Oftentimes consumers would like to utilize their newly purchased products immediately after purchase as is enabled by the present invention.

### BRIEF SUMMARY

The invention described herein represents a significant improvement in providing a low cost infrastructure to enable consumers to buy products that include rechargeable batteries that are fully charged when purchased by consumers.

### Objects and Advantages

Accordingly, several objects and advantages of the present invention are apparent. It is an object of the present invention to provide an inexpensive durable means for charging batteries while they are contained within their product packaging. It is an advantage that the present invention enables consumers to utilize products immediately after purchase without having to wait for batteries to be charged. A retailer whose products can be utilized immediately after purchase can charge a premium for such products because often consumers will be willing to pay more for such products. Additionally a retailer whose products are all fully charged will be able to attract consumer's to their store and thus it is a differentiator that can drive sales of those products and others that the consumer needs while at the store.

The power adaptors describe herein offer the advantage of being able to power devices through wireless energy when that is available or through wired electricity when that is more practicable and efficient.

Further objects and advantages will become apparent from the enclosed figures and specifications.

### DRAWING FIGURES

FIG. 1 illustrates a product packaging allowing access to battery charger electrical contacts.

FIG. 2 illustrates the product packaging of FIG. 1 with a cutaway view displaying some packaged contents.

FIG. 3 illustrates product packaging incorporating conductive elements that enable a packaged battery to be charged by an external charger.

FIG. 4 illustrates a box of batteries with conductive contacts integrated into the packaging for charging a plurality of batteries on display.

FIG. 5 illustrates a packaged product with a wirelessly chargeable battery contained in the packaging.

FIG. 6a is a cutaway view of a charger operable in a first mode of electricity input and in a second mode of wireless energy input.

FIG. 6b is a cutaway view of the device of FIG. 6a configured as a power adapter operable in two modes to power devices plugged therein.

FIG. 6c is a cutaway view of the device of FIG. 6b operable in a single wireless mode to power devices plugged therein.

FIG. 7a is a flowchart depicting relationships of hard wired charger elements and processes.

FIG. 7b is a flowchart depicting relationships of wireless charger elements and processes.

FIG. 8 depicts a charging element integrated into a product packaging containing a rechargeable battery.

FIG. 9a illustrates a wirelessly powered light pixel integrated with a product packaging.

FIG. 9b illustrates an LED emitter with forward and reverse biased LEDs for efficient operation with no need for a rectifier.

FIG. 10a illustrates a reward substrate that changes state in a wireless retail environment.

FIG. 10b illustrates a process for creating and operating a reward substrate that changes state in a wireless retail environment.

FIG. 11a depicts the components of FIGS. 6a and 6b with a rectification circuit illustrated.

FIG. 11b includes the components f FIG. 11a except the three prong plug has be unplugged and the power is being provided wirelessly as has been previously discussed.

FIG. 11c is a power adaptor engineered to be able to plug into a 60 hertz outlet to power a load in a first mode and to be able to receive power wirelessly at a frequency other than 60 hertz.

FIG. 12 illustrates a wireless primary induction coil providing wireless energy to an arrayed plurality of secondary induction coils for the purposes of powering a work load.

### NUMERALS IN FIGURES

21 product packaging
21a alternate product packaging
21b battery display package
21c sealed product packaging
21d alternate sealed product packaging
22 packaged product
23 product packaging indicia
24 illuminated indicia punch-out
25 packaging through port
25a alternate packaging through port
26 packaging compartment
26a LED packaging support
27 packaged battery charger
27a power adaptor
27b alternate power adaptor
27c tunable power adaptor
27d arrayed coil plurality power adaptor
28 film diffuser
29 retailer electric plug contacts
30 modulateable pixel
31 retailer electrical utility
31a consumer electric utility
32 retailer shelving
33 packaged charger plug
35 packaged battery
35a alternate packaged battery
35b first displayed battery
35c second displayed battery
37 packaged charger conductor contact
38 circuit indicator LED
38a battery indicator LED
38b wireless packaging LED
39 alternate packaged battery conductor contact
39a contact for first displayed battery
39b contact for second displayed battery
40 retailer charger
41 retailer electrical conductor contacts
41a alternate retailer electrical conductor contacts
43 packaging mounted conductor contacts
43a first battery package corporate contact
43b second battery package corporate contact
45 first battery box compartment
45a second battery box compartment
46 top side of battery display package
47 first bias LED in wireless light
49 second bias LED in wireless light
51 retailer wireless charger
51a induction coil
51b 1000 Hz first remote primary induction coil
51c 1000 Hz second remote primary induction coil
53 packaged wireless charger
53a charger integral wireless charger
53b wireless charger packaged secondary element
53c battery integral packaged wireless charger
53d wireless LED power coil
53e LED wireless light induction coil
53f 1000 Hz secondary induction coil
54 packaged battery charger circuit
55 alternate packaged battery
56 first plug-in power adaptor
57 second plug-in power adaptor
59 charger integral pimary induction coil
59a 1000 Hz primary induction coil
61 charger element
61a charge status circuit
61b wireless charger primary element
63 product element
65 power off sequence
67 power on sequence
71 wireless charging energy
73 wireless charge status dialog element
81 battery element
83 product packaging element
85 retailer infratructure element
91 coil packaging
93 packaging integrated charger coil
95 packaging charger affixing space
96 dialog element
97 packaging integrated charger coil hardwired to battery
98 rectifier element
98a rectifier circuit for LED power
98b 60 Hz rectifier
98c 1000 Hz rectifier
99 packaging support for packaging LED
100 consumer mailing address
101 wireless inducer
101a powered wireless inducer
103 printed connection
105 first indicator in first state
107 first possible reward
109 second indicator in first state
109a second indicator in second state
111 second possible reward
113 unique identifier
115 offer indicia
117 substrate
119 audible enunciator first state
119a audible enunciator second state
131 substrate production step
133 mail to consumer step
135 wireless energy environment step
137 energy modulates state step
139 consumer sees or hears modulated state step
141 store provides reward step
143 variability algorithm
145 location specific algorithm
147 randomness algorithm
176 bypass circuit
177 tunable oscillation circuit
179 first contact substrate
181 second contact substrate

### DETAILED DESCRIPTION OF THE INVENTION

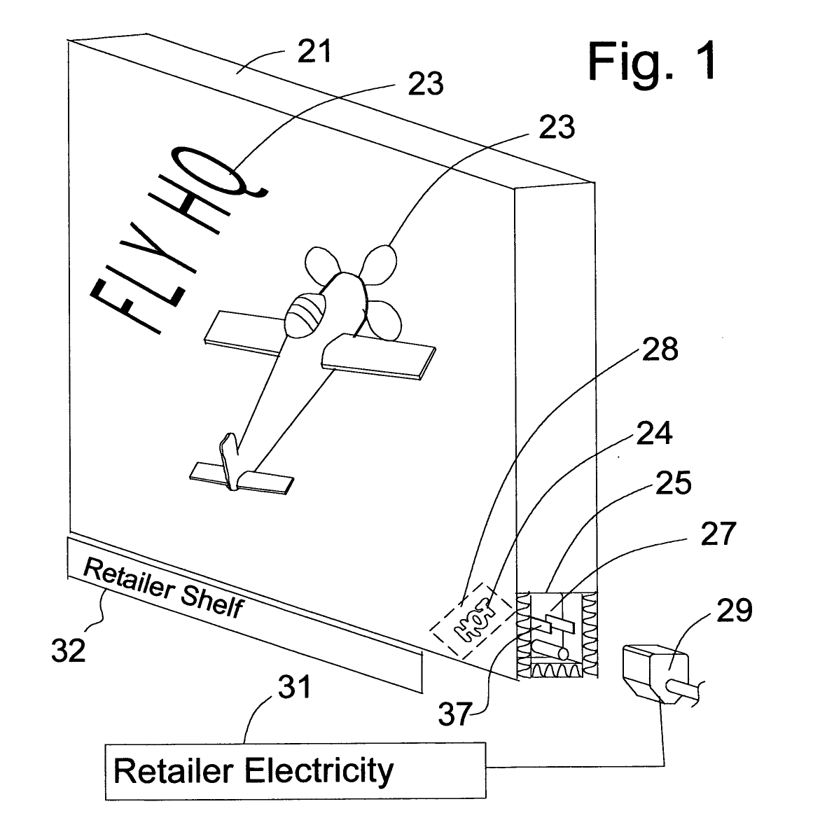

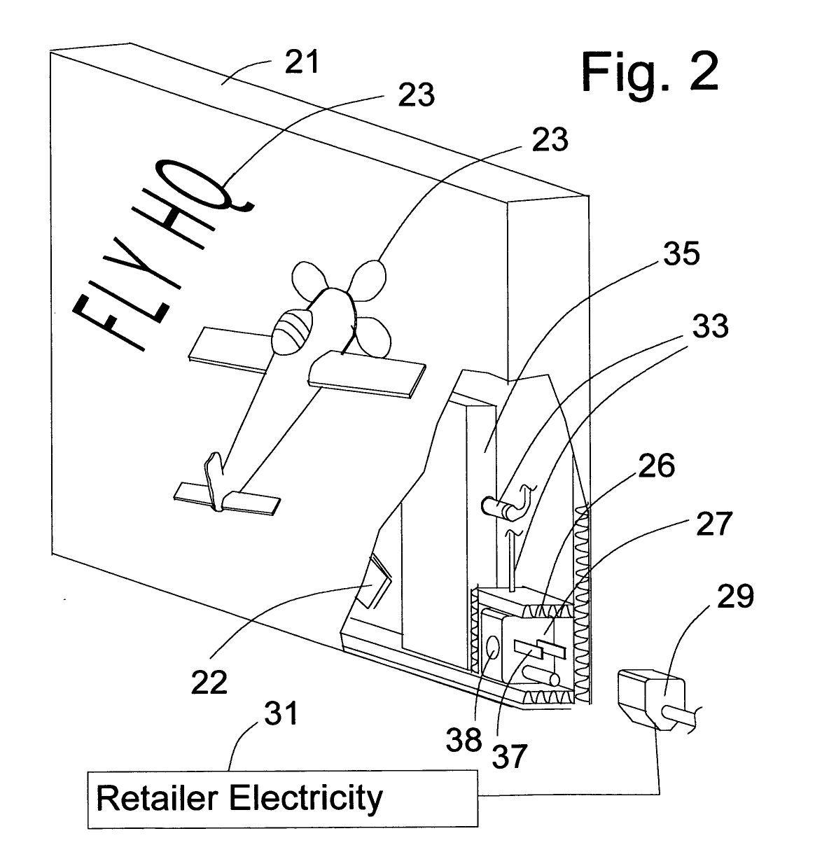

FIG. 1 illustrates a product packaging allowing access to battery charger electrical contacts. A product packaging 21 comprises a container of a product which offers benefits common to product packaging including protecting the product inside and displaying of a product packaging indicia 23 including pictures and alphanumeric characters that describe the product within. The product packaging is manufactured from cardboard and other materials and processes well known to those skilled in the art of product packaging. A packaging through port 25 comprises an opening in the product packaging wall which enables access to a packaged battery charger 27 contained within the package such that the packaged battery charger 27 can become in electrical communication with a retailer electric plug contacts 29 that is integrated into a retailer electrical utility 31 infrastructure that is provided by a retail or product distribution facility. The packaging through port 25 can be a break in the packaging that is fabricated to be open during manufacturing or which a worker subsequently opens for the purpose described herein. The packaged battery charger 27 is of the type that is sold with millions of products and which is designed to integrate on a first electricity input end of a circuit with an external electricity source which can be AC such as a wall outlet or can be DC such as a cigarette lighter and to integrate on a second electricity output end of a circuit with a battery that is to be charged. If the input electricity is AC and the output electricity is DC such charges commonly comprise a rectifier and such chargers commonly comprise transformers. The chargers and power adaptors herein may comprise oscillator circuits to oscillate current or modulate a wireless energy. The retailer electrical utility 31 can be standard AC electricity wired to the shelf including a standard female 2 prong plug or female 3 prong plug such as depicted in FIG. 1. A retailer shelving 32 can be a standard retail shelf upon which product packages can be placed for display as part of the product distribution cycle where the product is manufactured, packaged, warehoused, shipped, displayed, and purchased. The retailer shelving is also present in FIGS. 2 through 9 although not depicted. In practice, the product package is first manufactured for example from a cardboard box, then the product and other contents described herein are placed within, then the package and contents are stocked on the shelf, the electric plug contacts are brought into electrical communication with the electric contacts of the packaged battery charger 27 so that it can charge the battery contained within the product packaging 21 as depicted in FIG. 2. When a consumer purchases the product, the battery (shown in FIG. 2) within the product packaging 21 is fully charged and ready to immediately be utilized by the consumer. The packaged battery charger 27 has a packaged charger conductor contact 37 that enables it to electrically communicate with the retailer electric plug contacts 29 via electrical contacts therein (not shown). The product packaging 21 comprises an illuminated indicia punch-out 24 which comprises a hole in the product packaging 21 which, during manufacturing, is cut out in the shape of a word or other meaningful shape by a machine stamping process and through which light can pass to be observed by a consumer according to FIG. 2 and other figures herein. A film diffuser 28 is a translucent light filter that is glued to and integrated with the product packaging 21 such that light passing there through can be observed by consumers.

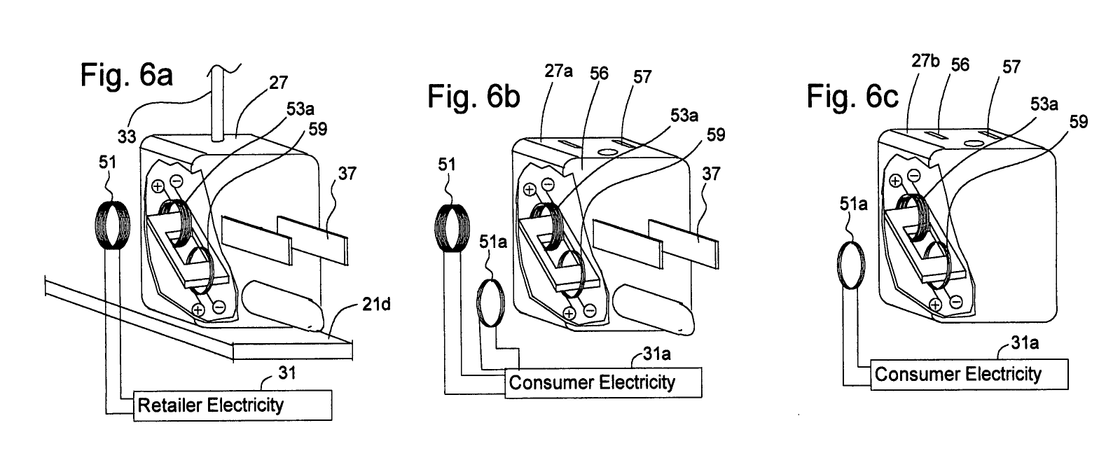

FIG. 2 illustrates the product packaging of FIG. 1 with a cutaway view displaying some packaged contents. A packaged product 22 is the core product that the product packaging 21 contains, protects, and that the product packaging indicia 23 describes, and is intended for purchase by a consumer. The battery discussed herein can be housed within the product or in a separte compartment within the product packaging as depicted herein. A product packaging compartment 26 comprises structural elements to keep the packaged battery charger 27 in place and from falling out of the packaging through port 25 of FIG. 1. Many packaging types and methods are widely known for separating elements within packaging to ensure they are not damaged during transport and display. The packaged battery charger 27 comprises a packaged charger plug 33 that comprises electrical wires to carry an electric current from the charger to a packaged battery 35. The packaged charger plug 33 also comprises a jack that plugs into the packaged battery 35 or in the case when a packaged battery is housed within a packaged product the packaged charger plug 33 jack plugs into the packaged product containing the packaged battery. In either case, within the packaging, the packaged battery is in electrical communication with the packaged charger such that it can be charged from external electricity provided through electrical contacts passing through the wall of the packaging and then through the charger to charge the battery. The input and output contacts on or connected to chargers and power adaptors herein can be wires, male plugs, female plugs, or another type. The packaged battery 35 comprises a rechargeable battery of the type that is currently sold to consumers by the millions for use in a wide variety of products. In designing the product packaging and placing the contents therein, the contact elements of the battery changer are positioned so as to be accessed through the throughport so as to receive electrical current and the charger plug is plugged into the battery (or indirectly brought into electrical commutation therewith) such that the charger can communicate an electrical current to the battery for the purposes of charging the battery while it is still contained within the product packaging. The battery is housed within or affixed to the product packaging to protect it during distribution. In operation, the battery comprises a workload for the battery charger. A circuit indicator LED 38 is configured to indicate a charge condition such as becoming illuminated when the battery is charging, or when the charger is receiving input current, or when the battery is fully charged. Such circuits being integrated with chargers of the prior art. Light from the circuit indicator LED 38 providing illumination from the inside of the packaging that is observable on the outside of the packaging through the illuminated indicia punch-out of FIG. 1. In a first mode of operation, the packaged battery charger 27 in FIG. 2 is said to be in wired electrical communication with the battery charger of FIG. 2. As described in FIG. 6a, the packaged battery charge is also operable in a wireless second mode of operation.

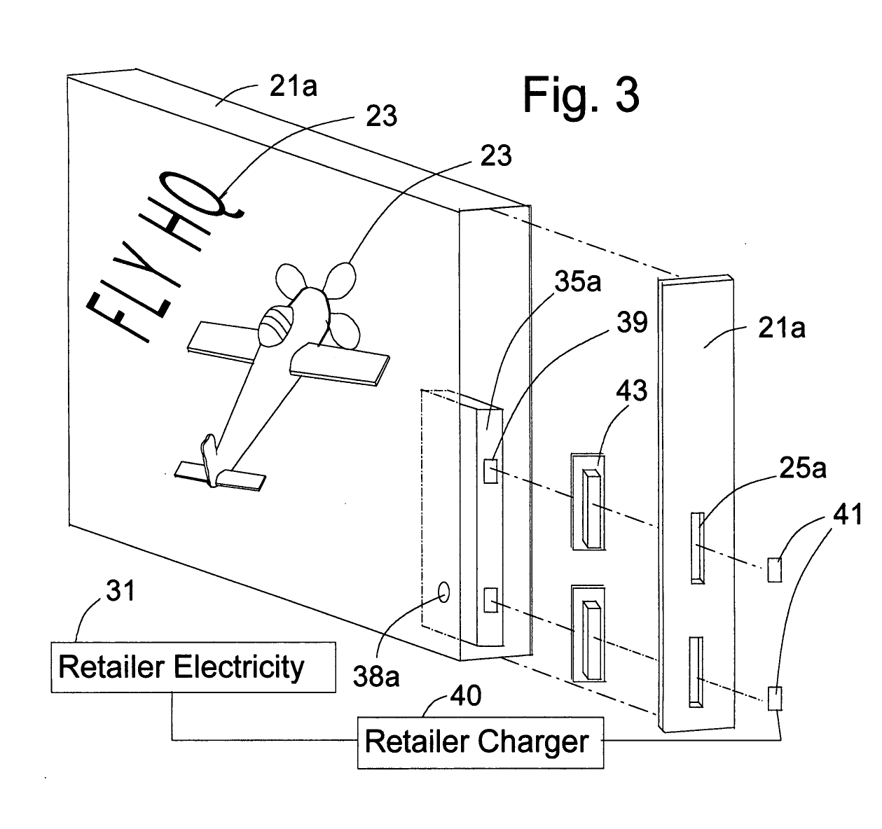

FIG. 3 illustrates product packaging incorporating conductive elements that enable a packaged battery to be charged by an external charger. An alternate product packaging 21a is manufactured similarly to that described in FIG. 1 with additional attributes to enable in package battery charging through conductive elements that are integrated into the alternate product packaging 21a. An alternate packaging through port 25a is a hole in the side of the alternate product packaging 21a such that a protruding portion of packaging mounted conductor contacts 43 can be affixed to the product packaging during manufacturing and subsequently communicate electrically with a retailer electrical conductor contacts 41 while also communicating with an alternate packaged battery conductor contact 39 which is affixed to an alternate packaged battery 35a. In the manufacturing of the alternate product packaging 21a, the alternate packaging through port 25a is machine punched out such that a flat flange portion of the packaging mounted conductor contacts 43 can be glued to be affixed to the alternate product packaging 21a to protrude there from. The alternate product packaging 21a is designed such that when the alternate packaged battery 35a is placed within, it is reliably kept in contact with the packaging mounted conductor contacts 43. The retailer electrical conductor contacts 41 are positioned on the retailer shelf such that the packaging mounted conductor contacts 43 contact the retailer electrical conductor contacts 41 and an electrical current is passed there through from a retailer charger 40. The retailer charger 40 receives electrical current from the retailer electrical utility 31 and provides a current to charge the alternate packaged battery 35a and the retailer charger 40 can contain elements similar to many known chargers including a full wave rectifier circuit, a voltage regulator circuit, automatic shut off circuit, and a charge status indicator output means such as a indicator LED. (Note that any of the chargers and power adaptors referenced herein may include these elements as well.) Once the alternate packaged battery 35a begins receiving a charge or is fully charged, a battery indicator LED 38a can become illuminated to become visible through the product packaging as previously described herein. When the product packaging of FIG. 3 is placed upon the shelf the packaging mounted conductor contacts 43 are reliably and continuously brought into contact with the retailer electrical conductor contacts 41. When a consumer buys the product, the batteries therein are fully charged and ready to be utilized immediately.

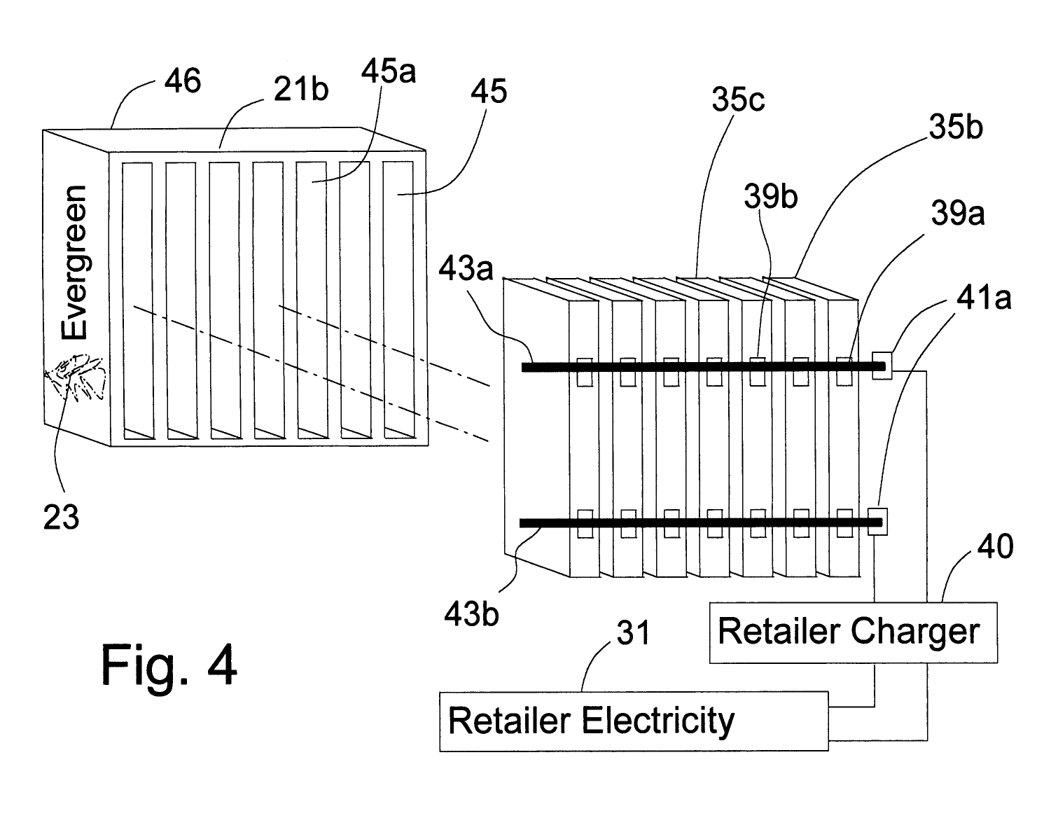

FIG. 4 illustrates a box of batteries with contacts integrated into the packaging for charging a plurality of batteries on display. A battery display package 21b is manufactured similar to other packages previously discussed herein. Its purpose is to display a plurality of batteries for sale and to enable the plurality to be concurrently charged by a retailer charging system. As was previously described, the battery display package 21b comprises a product packaging indicia 23 that displays logos and information about the package's contents. During manufacturing a first battery box compartment 45 is created which ensures that a contact for first displayed battery 39a of a first displayed battery 35b is continually in contact with a first battery package corporate contact 43a. During the packaging manufacturing process, the first battery package corporate contact 43a and a second battery package corporate contact 43b are both affixed to the bottom (not shown) of the battery display package 21b such that when a plurality of batteries are place therein, they are in electrical communication with the corporate contacts. The packaging is fabricated to receive a second displayed battery 35c which is placed within a second battery box compartment 45a such that its contact for second displayed battery 39b is reliably in contact with the first battery package corporate contact 43a and another of its contacts is reliably in electrical communication with the second battery package corporate contact 43b. The battery product package is placed upon the retailer shelf (not shown) the first and second corporate contacts are brought into electrical communication with a set of alternate retailer electrical conductor contacts 41a through which an electrical charge passes to be stored within the plurality of batteries. The alternate retailer electrical conductor contacts 41a carries a current from a retailer charger 40 which receives AC current from the retailer electricity infrastructure and contains circuits common to chargers as discussed herein for conditioning the current to be compatible with the batteries. The battery display package 21b having a top side of battery display package 46 through which consumer's can remove a single battery for purchase while the other batteries are still reliably in electrical communication with the first battery package corporate contact 43a and the second battery package corporate contact 43b. The battery that a consumer removes from the package and purchases is fully charged and ready for immediate use.

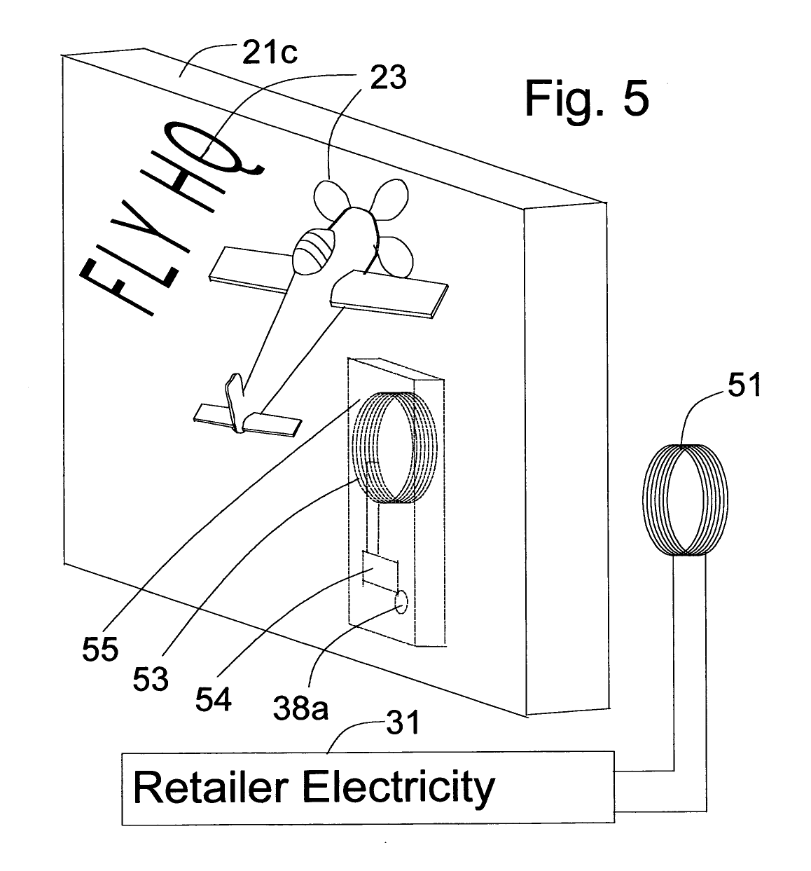

FIG. 5 illustrates a packaged product with a wirelessly chargeable battery contained in the packaging. A sealed product packaging 21c is manufactured according to the processes described herein. When placed upon the retailer shelf (not shown) it is within the range of a wireless energy source which is known in the prior art such as an RF energy, RFID, a magnetic filed, an electric field or an electromagnetic energy. In a preferred embodiment a resonance energy presently dubbed “WiTricity” is utilized due to its inherent efficiency, its operational distance, and the power magnitude that it makes possible. The wireless energy source is emitted by a retailer wireless charger 51 which is a wireless emitter of energy that is transferred through oscillation or modulation from an induction coil at a oscillation frequency such that the retailer wireless charger 51 establishes a resonance with a packaged wireless charger 53 such that an electrical current is induced wirelessly from the retailer wireless charger 51 to the packaged wireless charger 53. The induced current is used to charge an alternate packaged battery 55. The prior art describes batteries that are integrated with wireless current inducers which are contained therein for the purpose of their being charged wirelessly, such batteries generally comprising a packaged battery charger circuit 54 which include elements such as a full wave rectifier circuit, a voltage regulator circuit, automatic shut off circuit, and a charge status indicator output means such as a battery indicator LED 38a which emits a visible indicator of charging status that can be observed by a consumer through an indicia punch-out in the product packaging as described previously. Wireless charging systems and associated circuits are know in the prior art that receive standard AC current such as from the retailer electrical utility 31 that powers the retailer wireless charger 51. Such wireless charging systems commonly comprising transformer circuits to condition current, oscillation circuits or modulation circuits to optimize resonance according to dimensions of inducers, and as with RFID readers such systems can also be configured to both emit energy to provide a wireless power source as well as to emit and receive modulated energy as part of a two way wireless dialog including modulation protocols that are well documented and widely utilized. Devices and processes that rely on such energy sources and modulated dialogs being described by the present inventor in U.S. patent application Ser. Nos. 11/224,163, 11/379,799 and a series of related applications each of which are incorporated herein by reference. Thus the present invention encompasses the wireless charging of batteries as well as wireless dialog between the retailer wireless charger 51 which comprises a primary induction means and the packaged wireless charger 53 which comprises a secondary induction means. Any of the induction means described herein may be induction coils. The dialog between the inducers may relate to the status of the battery charge, or about the product such as a unique identifier, or describe information that the retailer wishes to display on pixels (not shown) located on the product packaging. The dialog comprising a modulated signal from the retailer wireless charger 51 which is received by the packaged wireless charger 53 and Vic versa. The attributes described about the wireless chargers being applicable to the other similar induction coils throughout the present application.

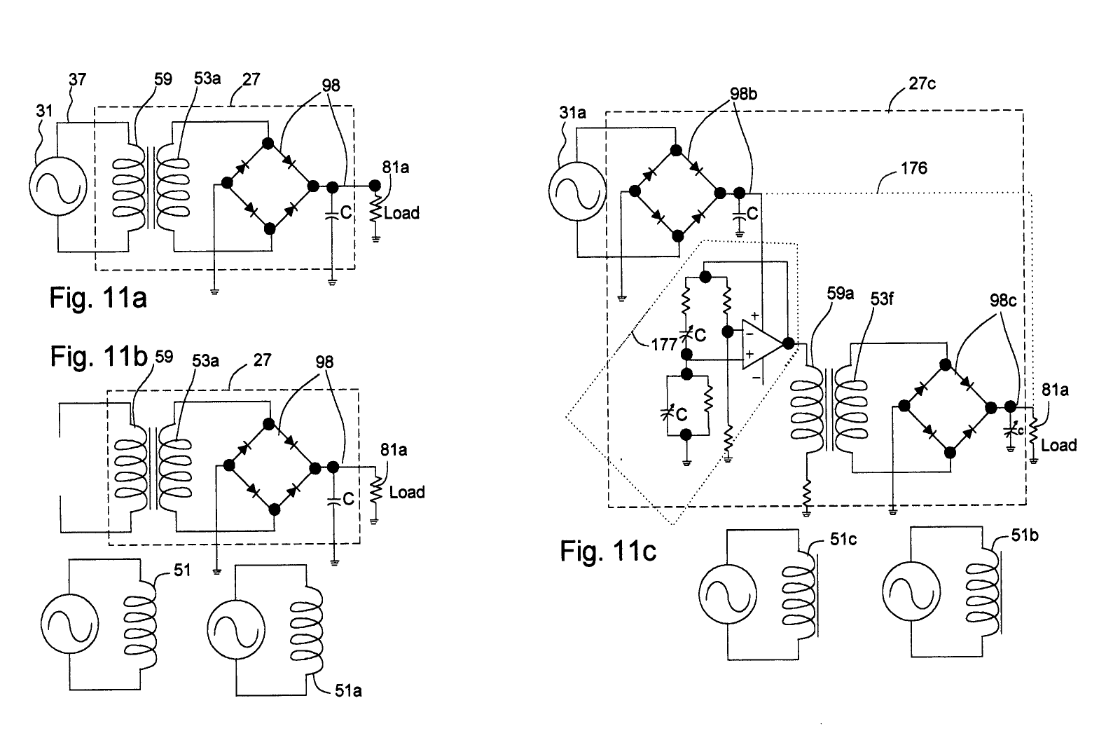

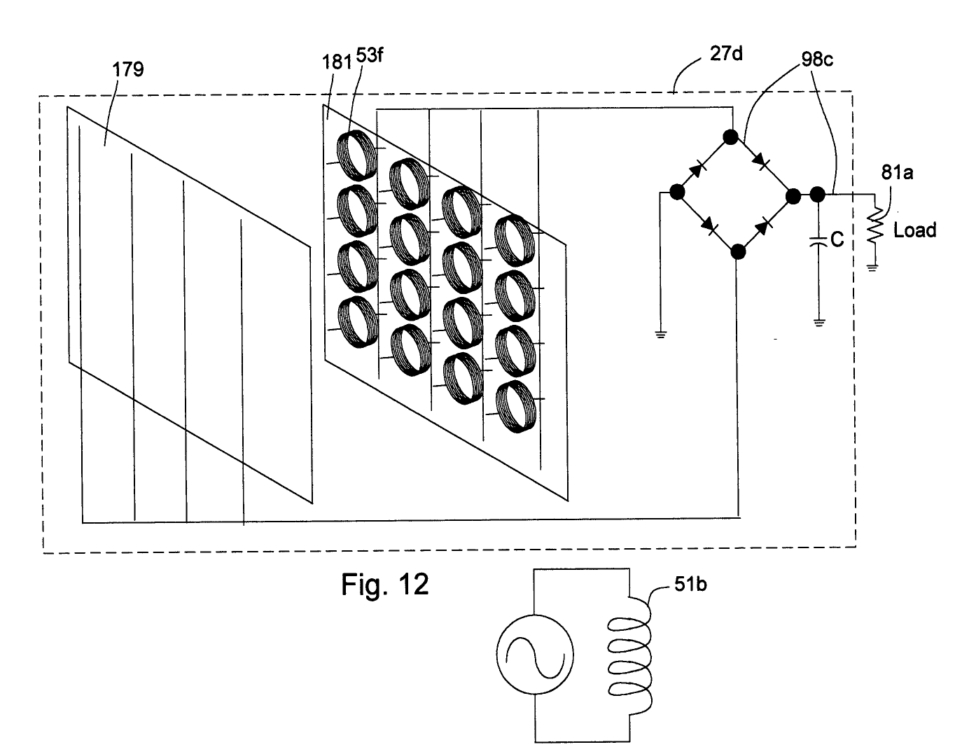

FIG. 6a is a cutaway view of a charger operable in a first mode receiving wired electricity as a plug-in charger and operable in a second mode as a wireless charger receiving energy wirelessly. An alternate sealed product packaging 21d is similar to that described in FIG. 1 except that no throughput opening in the packaging is required since a wireless means is utilized to charge the battery as described in FIG. 5 and FIG. 6b. As is described in FIGS. 1 and 2, the packaged battery charger 27 comprises a plug-in means including a packaged charger contact 37 such that in a first operational mode it can become in physical direct hardwired electrical communication with an electricity source such as the retailer electrical utility 31 which it converts to be suitable to charge the packaged battery 35 also referred to as a work load. As previously described, when the product is placed within the packaging, the packaged charger plug 33 is plugged into the battery directly as is depicted or indirectly (through the product in the case where the battery is contained within the product, not shown) such that while in the product packaging, the packaged battery charger 27 can charge the packaged battery 35. Whereas in FIG. 2 the means for providing energy to the packaged battery charger is a first mode of operation that of direct plug-in to the retailers electricity, by contrast, in FIG. 6b a second mode of operation is depicted, the means for providing energy to the packaged battery charger is a wirelessly induced current from the retailer wireless charger 51. As is described in FIG. 5 the retailer wireless charger 51 in FIG. 6b is configured to send energy wirelessly as a primary induction coil in resonance with a secondary induction coil so as to efficiently induce an electrical charge therein. Other suitable means for transmitting energy wirelessly are also know for substitution herein. By contrast with FIG. 5, retailer wireless charger 51 in FIG. 6b acts as a primary induction coil to induce a charge in a secondary induction coil namely a charger integral wireless charger 53a that is housed within the packaged battery charger 27. Thus in a first hardwired plugged-in operational mode the charger integral wireless charger 53a acts as a secondary induction coil that receives energy from a charger integral primary induction coil 59 that in turn receives electricity from a wall outlet or plug, and in a second wireless operational mode the charger integral wireless charger 53a acts as a secondary induction coil that receives energy from the retailer wireless charger 51, and in both operational modes, current passes from the charger integral wireless charger 53a through a circuit such as a rectifier and is stored within the packaged battery 35 as the work load. Note this is depicted as occurring within a retailer but the dual mode charger functionality described herein can be utilized anywhere. It is noteworthy that the packaged battery charger can also be configured such that the integral primary induction coil 59 receives a wireless energy from the retailer wireless charger 51 directly to induce a current into the charger for use in charging the packaged battery and in this configuration the retailer charger 51 is a primary inducer and the integral primary induction coil 59 is a secondary inducer and the charger integral wireless charger 53a is a tertiary inducer. According to the prior art of induction coils, the configuration of induction coils can be done in a variety of ways and the one illustrated in FIG. 6b is selected for illustrative purposes only, other configurations such as air core induction coils sharing a common axis may be are more suitable to operate in the dual modes described herein. In any case the packaged battery charger 27 comprises a means that is capable of charging a rechargeable battery (or otherwise powering a work load) in two different modes including a first mode such as is described in FIG. 2 where it can be plugged into electrical current and a second mode which is described in FIG. 6b where it receives energy wirelessly. The alternate sealed product packaging 21d is depicted to be on a retailer shelving 32 which is not shown. The packaged battery charger 27 comprises a casing which encases, has affixed thereto, or otherwise contains a plurality of wired electricity input contacts (such as packaged charger conductor contact 37), primary induction means (charger integral primary induction coil 59), secondary induction means (charger integral wireless charger 53a), and wired electricity output (packaged charger plug 33). The primary induction means (charger integral primary induction coil 59), secondary induction means (charger integral wireless charger 53a) comprise a transformer capable of conditioning current. Examples of wired input and output means include wires, female plugs, and male plugs. In FIG. 6a a third induction means (retailer wireless charger 51) is provided external to the casing of the packaged battery charger 27. The wireless energy in the first operational mode that passes from the primary induction means (charger integral primary induction coil 59) to the secondary induction means (charger integral wireless charger 53a) may be of a first type such as an electromagnetic energy suitable for traversing short distances efficiently and the wireless energy in the second operational mode that passes wirelessly between the third induction means (retailer wireless charger 51) to the second induction means (charger integral wireless charger 53a) may be of a second type such as a resonant magnetic energy that efficiently traverses greater distances wirelessly. Elements herein can be replaced by electromagnetic energy transmitters and receivers such s are common in RFID or devices operating in other pars of the wireless energy spectrum. Each of the induction means can be preconfigured to operate at a desired oscillation or resonant frequency. When utilized in the US, the wired electricity input to the battery charger will be approximately 60 hertz such that the primary and secondary inducers operate at 60 hertz when in the first mode of operation. The third induction means (retailer wireless charger 51) may also operate at 60 hertz (sinusoidal curves) to leverage the circuits within the charger but for each of these three components other oscillation frequencies are also possible. As illustrated in FIGS. 11a through 12, a rectifier circuit can be added within the charger casing if DC electricity is the desired output, also an additional oscillator circuit can also be added to achieve a different oscillation frequency output from any of the induction coils.

When the consumer buys the packaged product, the battery therein is fully charged and ready for immediate use. The devices and processes described herein thus far comprise power adaptors drawn to charging batteries. However as is illustrated in FIGS. 6b, and 6c the art taught herein has applications to work loads beyond charging batteries.

FIG. 6b is a cutaway view of the device of FIG. 6a adapted as a power adapter to power devices plugged therein. The power adaptor 27a is identical in construction and manufacture to the packaged battery charger discussed previously except the packaged charger plug 33 has been removed and replaced by female plug-in receptacles and associated electrical contacts including a first plug-in power adaptor 56 and a second plug-in power adaptor 57 these adaptations enable the power adaptor to receive electrical plugs and to thereby power a wide variety of devices comprising a work load such as a lamp or a computer for example. Thus a consumer electric utility 31a is depicted since the power adaptor 27a can be utilized in a retail location or elsewhere. Also the elements of FIGS. 6a, 6b, and 6c need not be utilized exclusive from within retail product packaging. If the device of FIG. 6b is to provide AC power at 60 Hertz, 60 hertz current can be input and output without a rectifier circuit, however it is also possible that 60 hertz can be input, converted to DC by a rectifier circuit, and an oscillator circuit can be added to oscillate current at a different desired Hertz rate as depicted in FIGS. 11c and 12. If AC is to be converted to DC, a rectifier circuit can be added without any need for an oscillation circuit.

FIG. 6c is a cutaway view of the device of FIG. 6b without the direct plug-in input hardware. An induction coil 51a is identical to the retailer wireless charger 51 except that the windings and diameter are different such that it operates at a different resonance than does the retailer wireless charger 51. Whereas the induction coil 51a can resonate with the charger integral primary induction coil 59, the retailer wireless charger 51 can resonate with the charger integral wireless charger 53a. Thus as depicted in FIG. 6b, a single power adaptor can interface with two distinct remote wireless energy means. As discussed in FIG. 6a, the external induction coil can be configured to resonate with either of the induction coils that are within the casing. In such case the external induction coil (such as the induction coil 51a) is approximately identical with respect to material, shape, size, and number of windings to the induction coil with which it is to efficiently resonate, (either the charger integral primary induction coil 59, or the charger integral wireless charger 53a. Note that the device of FIG. 6c can efficiently capture two wireless power sources at two distinct resonances and modify the current to enable the alternate power adaptor 27b to power a wide range of work loads.

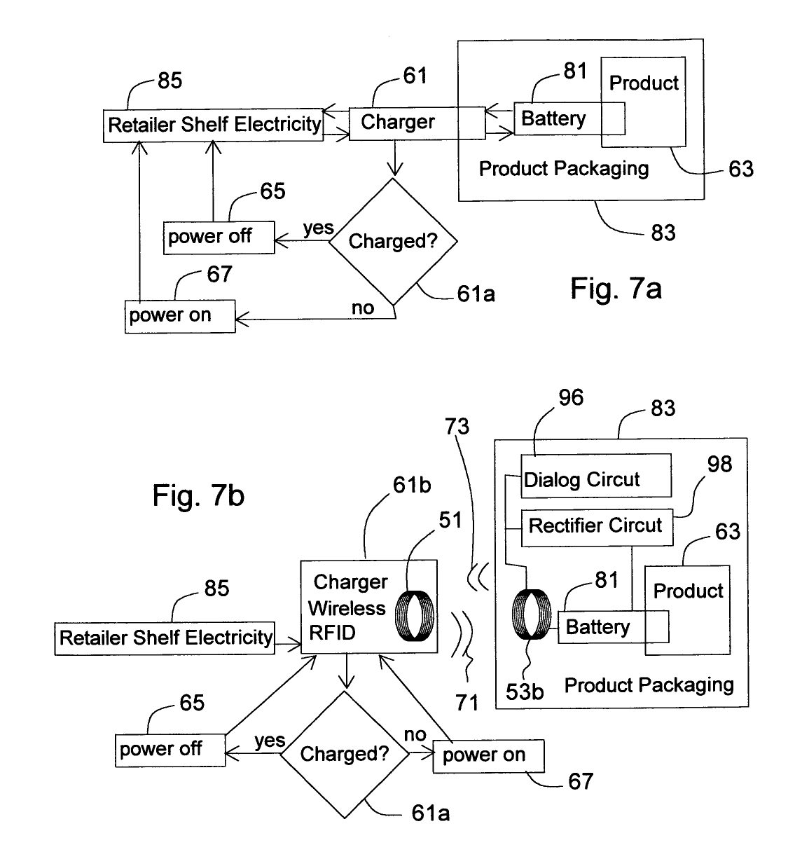

FIG. 7a is a flowchart depicting relationships of hard wired charger elements and processes. Such elements are described in FIGS. 1 through 4. A retailer infrastructure element 85 comprises electrical wiring and electricity delivered during product distribution by the retailer and shelving upon which the product packaging is placed for display or for storage such as in a warehouse or distribution facility. A charger element 61 receives retailer electricity and it generally includes at least one electrical circuit such as a full wave rectifier or a charge status circuit 61a which includes a means to sense a charge status and either execute a power off sequence 65 or a power on sequence 67 depending upon whether a battery element 81 is fully charged. The charger element 61 can be part of the retailer infrastructure that is in electrical contact with elements that penetrate the walls of a product packaging element 83 to charge the battery element 81 or the charger element 61 can be contained within the product packaging element 83 where it receives electricity from the retailer from wires or contacts that penetrate the wall of the packing to engage the charger electrically. To facilitate this, electrically conductive materials or contacts can be incorporated into the product packaging to reliably engage an electrical contact on the inside of the packaging such as a battery and an electrical contact on the outside of the product packaging such as the retailer's electrical infrastructure integrated with the retailer's shelving infrastructure. The battery element 81 can be packaged within the product packaging element 83 to be plugged directly into the charger element, alternately the battery element 81 can be housed within a product element 63 such that the charger element is plugged into the product element which in turn provides electrical connectivity to the battery element. In any case, the retailer's electricity passes through the charger element into the battery element which is contained within the product packaging element.

FIG. 7b is a flowchart depicting relationships of wireless charger elements and processes. Many of the elements of FIG. 7a are also applicable to the art of 7b the description here focuses on where there is a contrast with FIG. 7a. Also FIGS. 5, 6, 8, 9, and 10 describe wireless charging configurations further described in FIG. 7b. A wireless charger primary element 61b comprises the retailer wireless charger primary induction means that is part of a retailer's infrastructure. The wireless charger primary element is configured to receive electrical current and to transform it to be a wireless energy that can be modulated to resonate at a desired frequency that corresponds to the resonant frequency of a wireless charger packaged secondary element 53b such that an electrical current is efficiently induced by the wireless charger packaged secondary element 53b. which is then rectified by a rectifier element 98 and transformed by a circuit (not shown) and used to charge the battery element 81. In this process wireless charging energy 71 is emitted from the retailer wireless charger 51 in the form of a magnetic field, an electric field, or an electromagnetism. A wireless charge status dialog element 73 may also comprise an energy dialog element 96 between the wireless charger packaged secondary element 53b and the retailer wireless charger 51. Such a dialog can utilize protocols, apparatuses, unique identifiers, and processes for this purpose well know in the field of RFID circuits. The wireless charger packaged secondary element 53b may be an induction element within the charger element 61 in which case it can operate in either a hard wired mode to charge the battery element or a wireless mode to charge the battery. In the retail application of the present invention, a consumer who buys the product is able to utilize the batteries therein immediately.

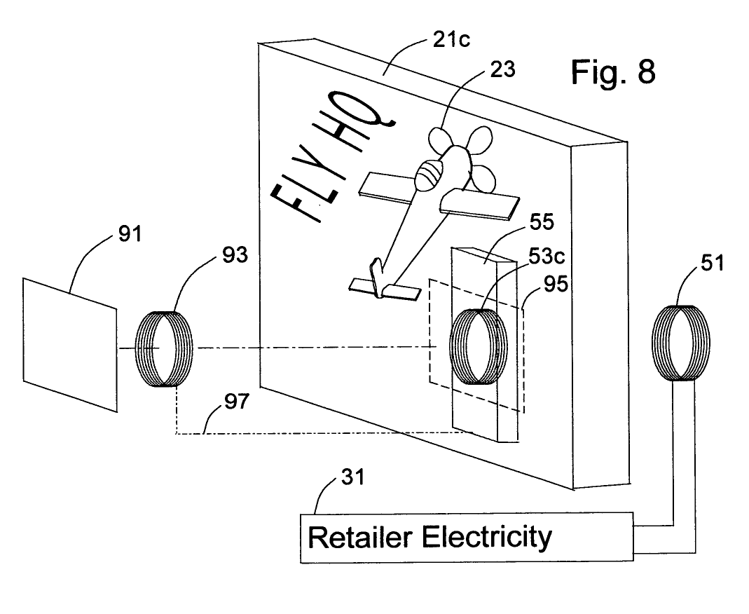

FIG. 8 depicts a charging element integrated into a product packaging containing a rechargeable battery. A sealed product packaging 21c is manufactured as previously discussed herein but modified to add a packaging integrated charger coil 93 into the sealed product packaging 21c during the package manufacturing process. A coil packaging 91 is a cardboard piece that sandwiches the packaging integrated charger coil 93 and associated circuit to become affixed to the sealed product packaging at a packaging charger affixing space 95. In operation, the retailer wireless charger 51 induces a current in the packaging integrated charger coil 93 as previously described herein through inducing a current wirelessly including in resonance. The packaging integrated charger coil 93 and associated circuit produce an electromagnetic induction which is used to induce a charge in a battery integral packaged wireless charger 53c which is packaged within the sealed product packaging 21c in close proximity to the packaging integrated charger coil 93. The induced current from the battery integral packaged wireless charger 53c is used to charge an alternate packaged battery 55 that is integrated with the battery integral packaged wireless charger 53c such as is practiced in the prior art of manufacturing batteries that integrate induction means for receiving a charge when being placed in close proximity or upon a plugged in battery charger several varieties of which are available to consumers. In the present invention, the packaging integrated charger coil 93 replaces the proximity battery charger of the prior art to enable a proximity battery to be charged within its product packaging by a charger that is integrated within the product packaging and that receives its energy from a more distant wireless energy source. In this configuration, the retailer wireless charger 51 is a primary induction means, the packaging integrated charger coil 93 is a secondary induction means, and the battery integral packaged wireless charger 53c is a tertiary induction means. In operation, after the product is purchased by the consumer, the packaging charge may be discarded in favor of using the proximity charger for future charges. Other circuits and processes described herein can be integrated with the packaging integrated charger coil 93 and the battery integral packaged wireless charger 53c for practical operation. In another embodiment, it is possible to provide direct wiring connectivity between the packaging integrated charger coil 93 and the alternate packaged battery 55 such as a packaging integrated charger coil hardwired to battery 97 which comprises wires that transfers electricity from a rectifier circuit (not shown) integrated with the packaging integrated charger coil to the battery that is contained within the product packaging. In any case, when the consumer purchases the product, the batteries within are fully charged.

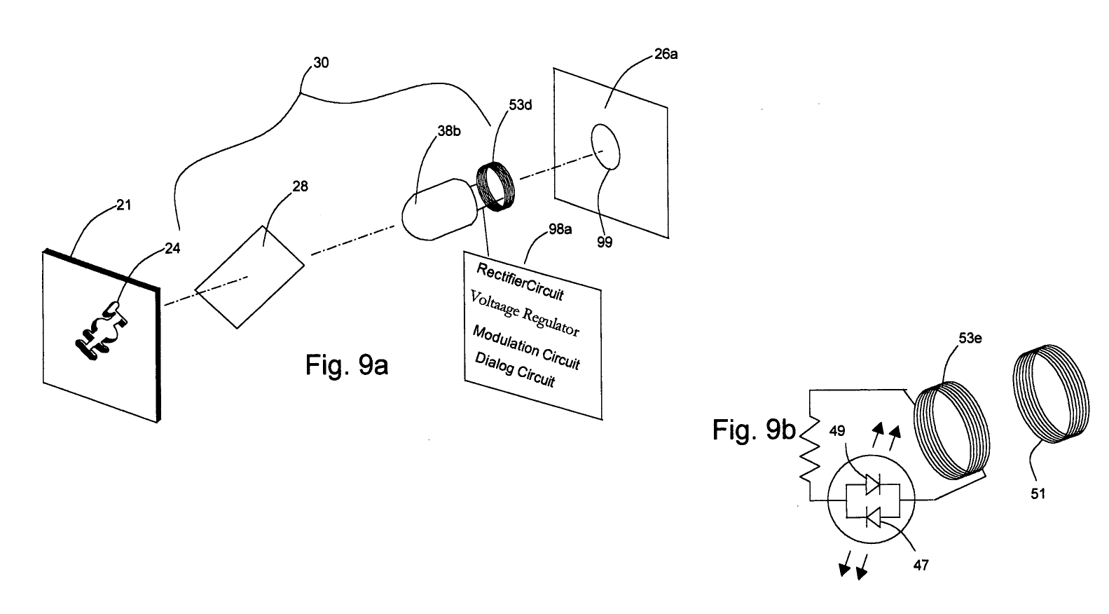

FIG. 9a illustrates a wirelessly powered light pixel integrated with a product packaging. The product packaging 21 can incorporate lighting pixels that leverage wireless energy in a retail environment to disclose information to consumers or to create a marketing advantage for selling products. A wireless packaging LED 38b is a standard LED that has been integrated with a wireless LED power coil 53d such that when the LED is within range of a wireless energy, the wireless LED power coil 53d induces an electric current that passes through a rectifier circuit for LED power 98a and then powers the wireless packaging LED 38b which emits light that can be observed by a consumer. The wireless packaging LED 38b is affixed to the product packaging 21 by a LED packaging support 26a which is a cardboard piece including a packaging support for packaging LED 99 into which the wireless packaging LED 38b fits and with which it can be affixed to the product packaging 21. As previously discussed, light from the LED may pass from within the packaging through an illuminated indicia punch-out to be seen by consumers through the packaging. Alternately, the LED may be affixed to the external surface of the packaging. The rectifier circuit for LED power 98a may comprise a means to modulate the LED between an on state and an off state according to instructions transmitted wirelessly using RFID as discussed herein such that a modulatable pixel is created. Also the pixels described by the present inventor in U.S. patent application Ser. No. 11/379,799 and those related can be utilized herein and are incorporated herein by reference. Such modulate-able LEDs comprising a display pixel that can be modulated to display meaningful information when operated in plurality with an array of similar pixels.

FIG. 9b illustrates an LED emitter with forward and reverse biased LEDs for efficient operation with no need for a rectifier. A forward biased LED 49 is in a circuit together with a reverse biased LED 47 and a non-rectified induction coil 53e. In operation, the non-rectified induction coil 53e captures energy wirelessly and alternately produces a current in a first direction that powers the forward biased LED 49 and then produces a current in a second direction that powers the reverse biased LED 47. If the alternating current is 60 Hz or greater, the blinking effect of the LED will not be perceptible to human vision.

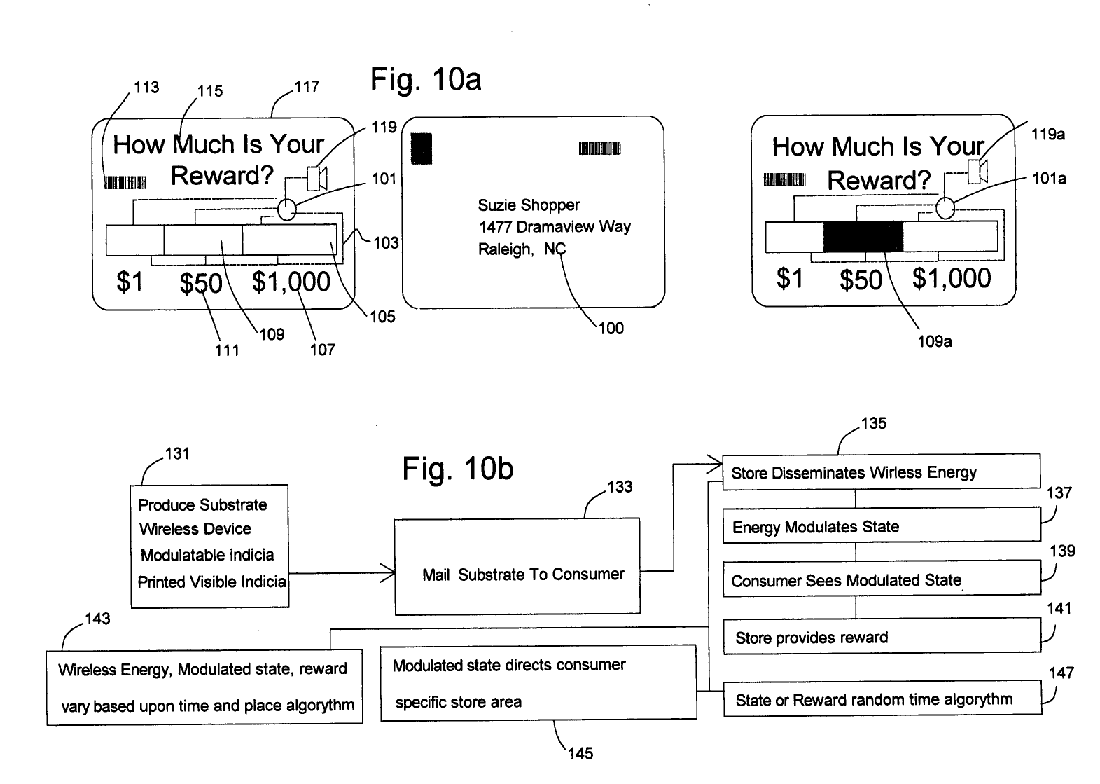

FIG. 10a illustrates a reward substrate that changes state in a wireless retail environment. According to the first panel of FIG. 10a, such a substrate 117 is first manufactured as a card with visible readable indicia printed thereon such as an offer indicia 115. Also printed on the substrate 117 are circuit elements comprising printed connections 103, a first indicator in a first state 105 and a second indictor in a first state 109. The modulatable indicators being LEDs or otherwise pixels that can be caused to change from a first visible state to a second visible state when powered to do so, such pixels being described by the present inventor as referenced above and also in the present application in FIG. 9, suitable organic LEDs (OLEDs) are also known in the prior art. Also affixed to the surface of the substrate is a wireless inducer 101 with integral rectifier circuit. The printed connection 103 comprises an electrical connection from the wireless inducer circuit to only one of the modulatable indicators such as the second indictor in a first state 109. Which modulatable indicator is connected to the printed connection is not visibly detectible at the completion of the manufacturing process. Additional indicia printed upon the substrate can include a first possible reward 107 and a second possible reward 111 each associated with a respective modulatable indicator. When the consumer receives the substrate she understands it represents some value according to the possible rewards printed thereon but is not aware of how much the value is. This is similar to a scratch-off ticket (of the prior art) in that the scratch off ticket has a concealed value affixed thereto when it is manufactured and the substrate described herein has a concealed value affixed thereto when it is manufactured but by contrast, the scratch-off can be removed in any setting to reveal the underlying value to the consumer and the present substrate will not reveal its value until a consumer brings it to the retailer whereupon the wireless energy in the retailer's store will power the wireless inducer which will cause only one of the possible reward indicators to modulate from a first visible state to a second visible state and thereby revealing the substrate's value to the consumer. This offers the advantage to the retailer of motivating the consumer to come to their store to claim the reward. The reward could potentially be large but in the vast majority of cases it will be quite small. The consumer is more motivated to go to the retail store by the chance that the reward could be large then they would be motivated to go to the store to claim a reward that they know is relatively small. Thus keeping the fact that the reward is small is a means to motivate consumers to come to the store. Also printed upon the substrate is a unique identifier 113 that can be a barcode read by a UPC reader or an RFID chip read by an RFID reader for the purposes of confirming the validity of the substrate and the reward thereon. The unique identifier and reward value having been logged into a database when the substrate was manufactured. An audible enunciator first state 119 can be affixed to the surface of the substrate during manufacturing and emit an audible signal when brought into the retailers wireless energy environment.

According to the second panel of FIG. 10a, upon the reverse side (second side) of the substrate 117 is printed a consumer mailing address 100 which enables efficient targeting and distribution to specific consumer targets.

The third panel of FIG. 10a, depicts the substrate 117 when it is brought into the retailers store. A powered wireless inducer 101a is receiving a wireless energy in the retail store as previously described herein. The retailer's wireless energy causes an induced current to be created by the powered wireless inducer 101a which is rectified if required and then utilized to power the printed connections 103 including the single modulatable visible indicator which is caused to visibly change from a first visible state to a second visible state. Reflective liquid crystals are suitable for this application since they are cheap, reliable, require little energy and can be bistable to remain in a first reflective state or a second absorptive state as desired. Note that since during manufacturing the circuit connects to a second indicator in second state 109a it is caused to modulate to visibly reveal the actual reward value to the consumer. Similarly, since during manufacturing the first indicator in first state 105 was not actually connected to the power circuit, it does not modulate to the second state. Thus during manufacturing the modulation state is predetermined but not revealed to the consumer until it is brought to the retail location where it is energized by the retailer's wireless energy system. An audible enunciator second state 119a is power by the powered wireless inducer 101a when it is brought within the retailers wireless energy field. Also the modulatable pixels described by the present inventor in U.S. patent application Ser. No. 11/379,799 and those related can be utilized herein and are incorporated herein by reference.

FIG. 10b illustrates a process for creating and operating a reward substrate that changes state in a wireless retail environment. In a substrate production step 131, the substrate is produced. The substrate comprises a piece of cardboard or other material to which is affixed a wireless device for capturing energy wirelessly, a printed visible indicia, and a device that can be modulated between a first visible state and a second visible state. The substrate in distributed to targeted consumers in a mail to consumer step 133. The consumer is motivated to bring the substrate to a retailer facility specified on the substrate where the provides a wireless energy environment step 135. The retailers wireless energy is received by the wireless device on the substrate and provides an energy modulates state step 137 charging the visible modulated device from a first visible state to a second visible state or changing an audible status from a first audible state to a second audible state. A consumer sees or hears modulated state step 139 comprises the consumer perceiving the state change and associates meaning with it. The store provides the consumer with a reward in a store provides reward step 141. The retailer may employ a variability algorithm 143 that determines the value of the reward depending upon any of a wide variety of algorithms such as a location specific algorithm 145 that requires the consumer to go to a specific area within the store or a randomness algorithm 147 such as for example advising the consumer that the card is worth $1 million dollars and in the details of the offer specifying that there will in fact be a slice of time and a specific space in one of the stores where if that card is present, it will be worth $1 million. The exact time and location when the card will be worth $1 million dollar would be a closely guarded secret generated by a random algorithm.

FIG. 11a depicts the components of FIGS. 6a and 6b with a rectification circuit illustrated. In the illustration, the three prong plug is assumed to be plugged into the retailer's electricity as the means of the alternating current. A work load 81a is any type of DC application such as charging a battery for example.

FIG. 11b includes the components of FIG. 11a except the three prong plug has been unplugged and the power is being provided wirelessly as has been previously discussed. Thus according to FIG. 11a, the packaged battery charger can operate in a first wired mode to power a load and according to FIG. 11b the packaged battery charger can operate in a second wireless mode to power a load. In the warless operational mode, the warless primary induction means can be manufactured to be substantially identical material, size, shape, and number of windings as the secondary induction means.

The art of FIG. 11a and 11b can be engineered to operate at any predetermined Hertz rate that is input into them.

FIG. 11c is a power adaptor engineered to be able to plug into a 60 hertz outlet to power a load in a first mode and to be able to receive power wirelessly at a frequency other than 60 hertz in a second mode. For the first operational mode, a 60 Hz rectifier 98b is provided which provides DC current to a tunable oscillation circuit 177 which conditions DC input to be a desired oscillating AC output such as 1000 Hz. The current then passes through a 1000 Hz primary induction coil 59a where it is transferred to a 1000 Hz secondary induction coil 53f then a 1000 Hz rectifier 98c to be the output DC current that drives the work load 81a. This illustrating a first wired mode of operation for a tunable power adaptor 27c. In the second wireless mode of operation, a 1000 Hz first remote primary induction coil 51b wirelessly powers either the 1000 Hz primary induction coil 59a or the 1000 Hz secondary induction coil 53f The 1000 Hz first remote primary induction coil 51b being manufactured to be nearly identical material, size, shape, and number of windings to one of those aforementioned two induction coils. A bypass circuit 176 may be added that enables DC current from the 60 Hz rectifier to power the workload without going through the oscillator circuit, transformer, rectifier combination. Also a transformer (not shown) may be added before the 60 Hz rectifier to condition the AC current prior to rectification. These circuits can be added such that the wired circuits from the AC plug to the transformer to the rectifier to the load comprise a first set of circuits which are nearly distinct from the wireless circuits which are powered by the remote induction means and condition current through either a secondary induction coil to the rectifier and then the load or through a secondary induction coil then a tertiary induction coil then the rectifier and then the load. The second wireless mode of operation can by performed by a 1000 Hz second remote primary induction coil 51c. Thus as is illustrated in FIGS. 6b, 11b, and 11c a single power transformer can be configured to selectively accept wired electricity, wirelessly energy through a first external induction means having a first set of physical characteristics, and wireless energy through a second external induction means having a second set of physical characteristics.

FIG. 12 illustrates a wireless primary induction coil providing wireless energy to an arrayed plurality of secondary induction coils for the purposes of powering a work load. A arrayed coil plurality power adaptor 27d is manufactured by affixing a plurality of induction mean such as a 1000 Hz secondary induction coil 53f to a first contact substrate 179 which comprises electrical connectivity of a first side of the 1000 Hz secondary induction coil 53f to a first side of the 1000 Hz rectifier circuit 98c and similarly provides electrical connectivity to the first sides of the plurality of induction means. The arrayed coil plurality power adaptor 27d further comprises a second contact substrate 181 with the plurality of induction mean such as a 1000 Hz secondary induction coil 53f being affixed thereto comprising electrical connectivity of a second side of the 1000 Hz secondary induction coil 53f to a second side of the 1000 Hz rectifier circuit 98c and similar electrical connectivity to the second sides of the plurality of induction means. In operation, the 1000 Hz first remote primary induction coil 51b emits a wireless energy which is captured by the plurality of induction means and se to power a work load.

### Operation of the Invention

Operation of the invention has been discussed under the above heading and to avoid redundancy is not repeated here.

### Conclusion, Ramifications, and Scope

Thus the reader will see that the battery charging apparatuses and processes described herein provide inexpensive, novel, unanticipated, highly functional and reliable means for charging batteries and powering work loads.

While the above description describes many specifications, these should not be construed as limitations on the scope of the invention, but rather as an exemplification of a preferred embodiment thereof. Many other variations are possible.

What is claimed:

1) A means for ensuring packaged batteries are charged during distribution of a packaged product comprising;
a product packaging,
a battery housed by said product packaging,
a battery charger,
an electrical power supply outside of said product packaging, and
said battery charger is any selected from the group consisting of;
housed by said product packaging and in wired electrical communication with said battery,
housed by said product packaging and in wireless energy communication with said battery,
outside of said product packaging and in wired electrical communication with said battery,
outside of said product packaging and in wireless energy communication with said battery,
and a first induction means outside of said product packaging cooperating with a second induction means housed by said product packaging,
and wherein electrical power from said electrical power supply is supplied from outside of said product packaging, through said battery charger, and into said battery housed by said product packaging.

2) The means for ensuring packaged batteries are charged during distribution of a packaged product of claim 1 wherein a wired connection is provided from an output side of said electrical power supply to an input side of said battery charger.

3) The means for ensuring packaged batteries are charged during distribution of a packaged product of claim 2 wherein said wired connection comprises an electrically conductive means that is affixed to said product packaging.

4) The means for ensuring packaged batteries are charged during distribution of a packaged product of claim 2 wherein said wired connection comprises an electrically conductive plug-in means.

5) The means for ensuring packaged batteries are charged during distribution of a packaged product of claim 1 wherein said battery charger comprises a means for conditioning electrical energy selected from the group consisting of, an induction means, a voltage transformer circuit, a rectifier circuit, an oscillator circuit, a charge shut off circuit, wireless dialog circuit, unique identifier circuit, and a charge status LED indicator circuit.

6) The means for ensuring packaged batteries are charged during distribution of a packaged product of claim 1 wherein said battery charger comprises a primary induction means and a secondary induction means.

7) The means for ensuring packaged batteries are charged during distribution of a packaged product of claim 1 wherein at least one of said induction means comprise an induction coil.

8) The means for ensuring packaged batteries are charged during distribution of a packaged product of claim 1 wherein said battery charger comprises
a primary induction means which on the input side is in wired communication with the electrical power supply and the output side transmits energy wirelessly and
a secondary induction means which on the input side receives energy wirelessly from the primary induction means and on the output side transfers energy to the battery through one selected from the group consisting of,
a wired connection to the battery,
and a tertiary induction means which is in wired communication to the battery.

9) The means for ensuring packaged batteries are charged during distribution of a packaged product of claim 8 wherein the primary induction means is outside of said product packaging and said secondary induction means is housed by said product packaging.

10) The means for ensuring packaged batteries are charged during distribution of a packaged product of claim 8 wherein said charging process comprises a first mode of operation and wherein in a second mode of operation a plug-in battery charger that can be plugged into a power source to operate as a battery charger without said primary induction means comprises any selected from the group consisting of; the secondary induction means, and the secondary induction means in cooperation with said tertiary induction means.

11) The means for ensuring packaged batteries are charged during distribution of a packaged product of claim 8 wherein said secondary induction means is or said tertiary induction means is affixed to said battery.

12) The means for ensuring packaged batteries are charged during distribution of a packaged product of claim 1 wherein as part of the battery charging process wireless energy passes from outside of said product packaging, through said product packaging and into said battery housed by said product packaging.

13) A power adaptor operable in two modes comprising,
a casing,
an electricity input connection,
a primary induction means comprising a wired electricity input side of a circuit and a wireless energy output side of a circuit,
a secondary induction means comprising a wireless energy input side of a circuit and a wired electricity output side of a circuit,
an electricity output connection,
a work load,
a third induction means which is external to said casing,
and wherein said casing houses the electricity input connection, the primary induction means, the secondary induction means, and the electricity output connection
and wherein in a first mode of operation electricity is supplied through the electricity input connection whereupon it enters the casing to the primary induction means where electricity is converted to a wireless energy to be transferred wirelessly to the secondary induction means where the energy is converted back to electricity whereupon it exits the casing through the electricity output connection to power the work load,
and wherein in a second mode of operation electricity is supplied to the third induction means which converts the electricity to a wireless energy which is transmitted from outside of the casing to within the casing and captured and used to power the work load in a manor selected from the group consisting of, energy from the third induction means is captured by the primary induction means, transferred to the secondary induction means and exits the casing to power the work load, and energy from the third induction means is captured by the secondary induction means, and exists the casing to power the work load.

14) The power adaptor operable in two modes of claim 13 wherein the third induction means operates in resonance with one selected from the group consisting of said primary induction means and said secondary induction means.

15) The power adaptor operable in two modes of claim 13 wherein
the primary induction means has a first set of physical characteristics pertaining to material, size, windings and shape and
the secondary induction means has a second set of physical characteristics pertaining to material, size, windings, and shape, and
wherein it at least one respect, the first set of physical characteristics differ in a predetermined way from the second set of physical characteristics,
And wherein the Third induction means has a set of physical characteristics pertaining to material, size, and shape that are selected from the group consisting of, substantial identical to those physical characteristics of the primary induction means, and substantial identical to those physical characteristics of the secondary induction means.

16) The power adaptor operable in two modes of claim 13 wherein a rectifier circuit is added within said casing such that oscillating energy or AC electricity entering the casing is converted to DC electricity exiting the casing.

17) The power adaptor operable in two modes of claim 13 wherein in the first mode of operation the input electricity entering the casing oscillates at approximately 60 hertz and wherein in the second mode of operation the wireless energy coming from the third induction means oscillates at approximately 60 hertz.

18) The power adaptor operable in two modes of claim 13 wherein the electricity input connection of the casing is selected from the group consisting of, a wire, a male plug adaptor, and a female plug adaptor.

19) The power adaptor operable in two modes of claim 13 wherein the electricity output connection of the casing is selected from the group consisting of, a wire, a male plug adaptor, and a female plug adaptor.

20) The power adaptor operable in two modes of claim 13 wherein the work load comprises any selected from the group consisting of charging of a battery, and a light emitter.
